(19) United States
(12) Patent Application Publication
(10) Pub. No.: US 2022/0180832 A1
(43) Pub. Date: Jun. 9, 2022

(54) Display Method, Display Optimization Apparatus, Electronic Device and Storage Medium

(71) Applicants: Fuzhou BOE Optoelectronics Technology Co., Ltd., Fuzhou (CN); BOE Technology Group Co., Ltd., Beijing (CN)

(72) Inventors: Hailong YU, Beijing (CN); Chuanhe JING, Beijing (CN); Jianming HUANG, Beijing (CN); Yabin LIN, Beijing (CN); Xuezhen SU, Beijing (CN); Xiaobo JIA, Beijing (CN); Wanping PAN, Beijing (CN); Hongjiang WU, Beijing (CN); Lu ZHAO, Beijing (CN)

(21) Appl. No.: 17/359,509

(22) Filed: Jun. 26, 2021

(30) Foreign Application Priority Data
Dec. 4, 2020 (CN) 202011407675.X

(51) Int. Cl. G09G 3/36; G09G 3/34

(52) U.S. Cl. CPC G09G 3/3607; G09G 3/3688; G09G 2320/0613; G09G 2360/16; G09G 3/3406

(57) ABSTRACT

Provided are a display method, display optimization apparatus, electronic device and storage medium. The display method includes: obtaining position information of N user eyes and original grayscale data of an image to be displayed, wherein N is a positive integer greater than 1; determining N pixel correspondences corresponding to the position information of N user eyes one-to-one based on the position information of N user eyes, wherein a pixel correspondence corresponding to position information of each user eye is a correspondence between pixels in a light control panel and pixels in a liquid crystal display panel under an angle of view corresponding to the position information of the user eye; adjusting original grayscale data according to N pixel correspondences to obtain target grayscale data; and outputting original grayscale data to the liquid crystal display panel and the target grayscale data to the light control panel to perform display.

### CROSS-REFERENCE TO RELATED APPLICATION

The present application claims the priority to the Chinese Patent Application No. 202011407675.X, filed to the CNIPA on Dec. 4, 2020, the content of which is hereby incorporated by reference.

### TECHNICAL FIELD

Embodiments of the present disclosure relate to, but are not limited to, the field of display technology, in particular to a display method, a display optimization apparatus, an electronic device and a storage medium.

### BACKGROUND

In a display apparatus, since there is usually a gap layer of 1 mm (millimeter) to 1.3 mm between two stacked display panels, under a certain angle of view, ghosting phenomenon is easy to occur, that is, user eyes observe that upper pixels and lower pixels do not coincide, which affects the visual experience. Improving the ghosting phenomenon is of great significance to improve display quality of display panels.

### SUMMARY

The following is a summary of subject matters described in detail in the present disclosure. This summary is not intended to limit the protection scope of the claims.

Embodiments of the present disclosure mainly provide following technical solutions.

In a first aspect, an embodiment of the present disclosure provides a display method, including:

obtaining position information of N user eyes and original grayscale data of an image to be displayed, wherein N is a positive integer greater than 1;

determining N pixel correspondences corresponding to the position information of the N user eyes one-to-one based on the position information of the N user eyes, wherein a pixel correspondence corresponding to position information of each user eye is a correspondence between pixels in a light control panel and pixels in a liquid crystal display panel under an angle of view corresponding to the position information of the user eye;

adjusting the original grayscale data according to the N pixel correspondences to obtain target grayscale data; and

outputting the original grayscale data to the liquid crystal display panel, and outputting the target grayscale data to the light control panel to perform display.

In a second aspect, an embodiment of the present disclosure provides a non-transient computer readable storage medium, which includes a stored program, wherein a device where the storage medium is located is controlled to execute acts of the display method described above when the program is run.

In a third aspect, an embodiment of the present disclosure provides a display optimization apparatus, including: a processor and a memory storing a computer program that is capable of running on the processor, wherein acts of the display method described above are implemented when the processor executes the computer program.

In a fourth aspect, an embodiment of the present disclosure provides an electronic device, comprising: a display apparatus, a binocular camera, and the display optimization apparatus in embodiments described above.

The display apparatus includes a light control panel and a liquid crystal display panel located on a light-emitting side of the light control panel.

The binocular camera is configured to capture a first image and a second image.

Other features and advantages of the present disclosure will be set forth in the following specification, and will become apparent partially from the specification, or be understood by practice of the present disclosure. Other advantages of the present disclosure can be realized and obtained by the solutions described in the specification and drawings.

Other aspects will become apparent upon reading and understanding accompanying drawings and the detailed description.

### BRIEF DESCRIPTION OF DRAWINGS

Accompanying drawings are used to provide a further understanding of technical solutions of the present disclosure, form a part of the specification, and explain technical solutions of the present disclosure together with embodiments of the present disclosure, while they do not constitute a limitation on the technical solutions of the present disclosure. Shapes and sizes of components in the drawings do not reflect true proportions and only to be used to schematically illustrate contents of the present disclosure.

FIG. 1 is a schematic diagram of a structure of a display apparatus according to an embodiment of the present disclosure.

FIG. 2A is a schematic diagram of a display effect of a display apparatus.

FIG. 2B is a schematic diagram of another display effect of a display apparatus.

FIG. 3 is a schematic flowchart of a display method according to an embodiment of the present disclosure.

FIG. 4 is a schematic diagram of another structure of a display apparatus according to an embodiment of the present disclosure.

FIG. 5 is a schematic diagram of a process of obtaining target grayscale data according to an embodiment of the present disclosure.

FIG. 6 is a schematic diagram of a structure of an electronic device according to an embodiment of the present disclosure.

FIG. 7 is a schematic diagram of a still structure of a display apparatus according to an embodiment of the present disclosure.

FIG. 8 is a schematic diagram of a structure of a display optimization apparatus according to an embodiment of the present disclosure.

### DETAILED DESCRIPTION

Multiple embodiments are described in the present disclosure, but the description is exemplary rather than limiting, and there may be more embodiments and implementation solutions within the scope of the embodiments described in the present disclosure. Although many possible combinations of features are shown in the drawings and discussed in the embodiments, many other combinations of the disclosed features are also possible. Unless specifically limited, any feature or element of any embodiment may be used in combination with or in place of any other feature or element of any other embodiment.

When describing representative embodiments, the specification may have presented methods and/or processes as a specific order of acts. However, to the extent that the method or process does not depend on the specific order of acts described in the present disclosure, the method or process should not be limited to the specific order of acts described. As understood by those of ordinary skills in the art, other orders of acts are also possible. Therefore, the specific order of acts set forth in the specification should not be interpreted as limitation to the claims. In addition, the claims for the method and/or process should not be limited to the acts performed in the written order, and those of skilled in the art may readily understand that these orders may vary which still remains within the spirit and scope of the embodiments of the present disclosure.

Unless otherwise defined, technical terms or scientific terms used in the embodiments of the present disclosure shall have common meanings as construed by those of ordinary skills in the art to which the present disclosure pertains. The words “first”, “second” and the like used in the embodiments of the present disclosure do not represent any order, quantity or importance, but are merely used to distinguish among different components. The words “include”, “contain” or the like mean that elements or articles before the words cover elements or articles listed after the words and their equivalents, without excluding other elements or articles. The words “connect”, “couple” or the like are not limited to physical or mechanical connection, but may include electrical connection, whether direct or indirect.

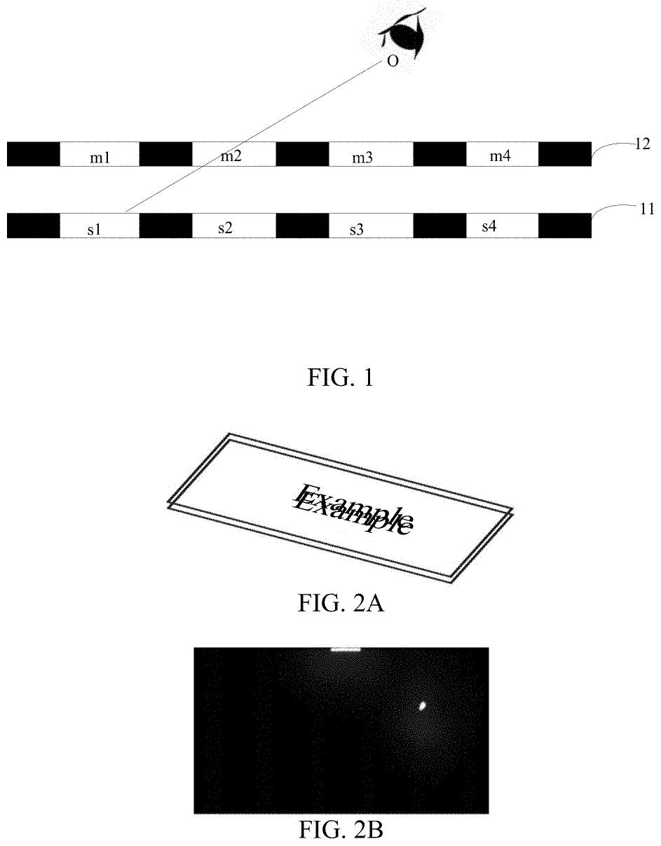

FIG. 1 is a schematic diagram of a structure of a display apparatus according to an embodiment of the present disclosure. As shown in FIG. 1, the display apparatus is a bonding structure of a two-layer display panel, which may include a light control panel 11 and a liquid crystal display panel 12 which are stacked. The light control panel 11 may be referred to as a sub-display panel (sub cell), and the liquid crystal display panel 12 may be referred to as a main display panel (main cell). The display apparatus may further include a binocular camera disposed on two sides of the display panel.

As shown in FIG. 1, in an original pixel correspondence between the liquid crystal display panel 12 and the light control panel 11, a first pixel in the light control panel corresponds to a second pixel in the liquid crystal display panel above the first pixel (for example, the first pixels s1 to s4 in the light control panel 11 correspond to the second pixels m1 to m4 in the liquid crystal display panel 12 one-to-one). However, due to structural limitations of the display apparatus itself, there will be a gap layer of 1 mm to 1.3 mm between the light control panel 11 and the liquid crystal display panel 12, which will cause that a pixel correspondence between the liquid crystal display panel and the light control panel changes under a certain angle of view O (determined by a position of a user eye relative to the display panel), resulting in a problem that the upper pixels and lower pixels do not coincide (that is, they do not correspond with each other) (for example, a second pixel m2 of the liquid crystal display panel should have coincided with a first pixel s2 in the light control panel. However, under a certain angle of view O, the second pixel m2 of the liquid crystal display panel actually does not coincide with the first pixel s2 in the light control panel, but coincides with a first pixel s1 in the light control panel). In this way, under a certain angle of view O, the contents displayed by the upper pixels and lower pixels do not coincide, which will cause a problem of ghosting. For example, as shown in FIG. 2A, under a certain angle of view O, the display content displayed by the display apparatus is ghosted, which makes the display effect worse and affects the visual experience of the user. In addition, under a certain angle of view O, it is easy for the user eyes to see the reflection of a metal layer in the display panel, which will further aggravate this phenomenon. The commonly way is to fuzzily processed the periphery of each pixel of the light control panel by using a local dimming technology, so that a display range of a white image of the light control panel is larger than a display range of an image of the liquid crystal display panel. Although this way may solve the problem of ghosting to a certain extent, it will produce a halo on the display panel (as shown in FIG. 2B), and the halo will be more evident in a dark environment.

An embodiment of the present disclosure provides a display method, which is applied to a display optimization apparatus. The display optimization apparatus, which is connected with the display apparatus, may be used to perform display optimization on the display apparatus, improve the ghosting phenomenon, improve the display quality of the display panel in the display apparatus, and enhance the visual experience of users.

In an exemplary embodiment, the display apparatus may be a display with a binocular camera, and the display optimization apparatus may be a host. Of course, embodiments of the present disclosure are not limited to this, or may be others. For example, the display apparatus may be a display of a television, and the display optimization apparatus may be a processor of the television. Here, the embodiments of the present disclosure are not limited to this.

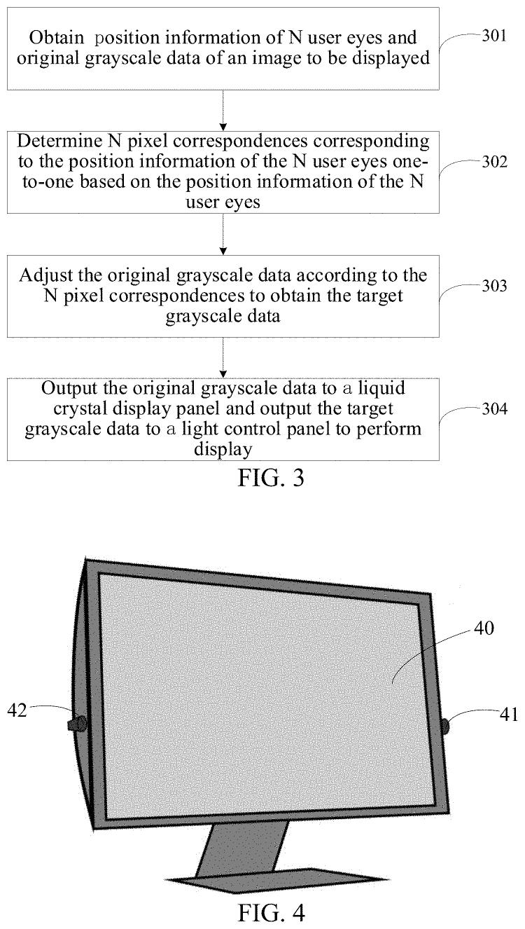

FIG. 3 is a schematic flowchart of a display method according to an embodiment of the present disclosure. As shown in FIG. 3, the display method may include the following acts.

In act 301, position information of N user eyes and original grayscale data of an image to be displayed are obtained.

Where, N is a positive integer greater than 1.

For example, when a user uses a display apparatus, N may be 2 (i.e., position information of a left eye and a right eye of the user relative to the display panel is obtained, and multi-angle of view display optimization of a single person may be realized by performing acts 302 to 304). When multiple users use the display apparatus together, for example, when two users share one display apparatus, N may be 4 (i.e., position information of the left and right eyes of multiple users relative to the display panel is obtained, and multi-angle of view display optimization of multiple persons may be realized by performing acts 302 to 304). Here, the embodiments of the present disclosure are not limited to this.

In an exemplary implementation, the original grayscale data of the image to be displayed is grayscale data when the liquid crystal display panel displays an image. The original grayscale data may include an original sub-grayscale value corresponding to each pixel in the liquid crystal display panel for enabling the pixel in the liquid crystal display panel to display. If both the liquid crystal display panel and the light control panel display according to the original grayscale data, the ghosting problem easily occurs under N angles of view corresponding to the position information of the N user eyes.

In an exemplary implementation, the position information of the user eyes refers to the position information of the user eyes relative to the display panel. Generally speaking, the position information of eyes of each user may include position information of a first eye of the user and position information of a second eye of the user.

In act 302, N pixel correspondences corresponding to the position information of the N user eyes one-to-one is determined based on the position information of the N user eyes.

In an exemplary implementation, the pixel correspondence corresponding to the position information of each user eye is a correspondence between pixels in the light control panel and pixels in the liquid crystal display panel under an angle of view corresponding to the position information of the user eye.

In act 303, the original grayscale data is adjusted according to the N pixel correspondences to obtain target grayscale data.

In act 304, the original grayscale data is output to a liquid crystal display panel and the target grayscale data is output to a light control panel to perform display.

In an exemplary implementation, the target grayscale data is grayscale data when the light control panel displays an image. The target grayscale data may include: sub-grayscale data corresponding to each pixel in the light control panel for enabling the pixel in the light control panel to display.

In this way, after the original grayscale data of the image to be displayed and the position information of N user eyes relative to the display panel are obtained, the correspondence between the pixels in the light control panel and the pixels in the liquid crystal display panel under an angle of view corresponding to position information of each user eye may be determined for the angle of view based on the position information of N user eyes, so that N pixel correspondences corresponding to the position information of N user eyes one-to-one may be obtained in real time according to current position information of N user eyes relative to the display panel. Next, the original grayscale data for enabling the liquid crystal display panel to display may be adjusted according to the N pixel correspondences determined in real time, and the target grayscale data for enabling the light control panel to display may be determined.

Thereby, the target grayscale data corresponding to the angles of view corresponding to the position information of the N user eyes is obtained. Finally, the original grayscale data is output to the liquid crystal display panel and the target grayscale data is output to the light control panel to perform display. Thus, according to the position information of the user eye, the pixel correspondence between the pixels in the light control panel and the pixels in the liquid crystal display panel is determined under the angle of view corresponding to the position information of the user eye, and the grayscale data of the light control panel is determined according to the pixel correspondence, so that content displayed by the pixel in the liquid crystal display panel correspond to content displayed by the pixel in the light control panel under the angle of view corresponding to the position information of the user eye. Therefore, the problem of non-coincidence will not occur, when the user views the display panel from any angle, the problem of ghosting will not occur. Thereby, the display effect is improved, and the visual experience of the user is improved.

In an exemplary embodiment, the position information of the user eyes relative to the display panel in a three-dimensional coordinate system may be obtained through two images captured by a binocular camera disposed in the display apparatus (for example, taking the display apparatus being a display as an example, as shown in FIG. 4, a first camera 41 and second camera 42 may be disposed on two sides of a display panel 40). Then, act 301 may include the following acts 3011 to 3013.

In act 3011, a first image and a second image are obtained through the binocular camera in the display apparatus.

In act 3012, the position information of N user eyes is obtained based on position information of the binocular camera, the first image and the second image.

In an exemplary embodiment, act 3012 may include the following acts 3012a and 3012b.

In act 3012a, first pixel positions of N user eyes in the first image and second pixel positions of N user eyes in the second image are determined by using a human eye recognition technology.

In act 3012b, the position information of N user eyes is calculated based on the position information of the binocular camera, the first pixel positions of N user eyes in the first image and the second pixel positions of N user eyes in the second image by using a binocular visual positioning technology.

For example, taking a user as an example, N is equal to 2. A first image and a second image are obtained by photographing images with a first camera and a second camera (that is, a binocular camera). Then, a first pixel position of the user first eye and a first pixel position of the user second eye are obtained from the first image and a second pixel position of the user first eye and a second pixel position of the user second eye are obtained from the second image by using the human eye recognition technology. Next, according to a principle of one-to-one correspondence between a pixel position in an image photographed by the cameras and a spherical coordinate axes, the first pixel position of the user first eye in the first image is converted into a first spherical coordinate system position of user first eye in the first image, the first pixel position of the user second eye in the first image is converted into first spherical coordinate system position of user second eye in the first image. And, the second pixel position of the user first eye in the second image is converted into the second spherical coordinate system position of the user first eye in the second image, and the second pixel position of the user second eye in the second image is converted into the second spherical coordinate system position of the user second eye in the second image. Finally, the spherical coordinate positions of eyes are converted into 3D coordinates in 3D space by performing conversion through combining the position information of the first camera and the position information of the second camera (that is, 3D coordinates of the user first eye are calculated according to the position information of the binocular camera and the first spherical coordinate system position and the second spherical coordinate system position of the user first eye, and 3D coordinates of the user second eyes are calculated according to the position information of the binocular camera and the first spherical coordinate system position and the second spherical coordinate system position of the user second eye). In this way, the position information of two user eyes corresponding to one user is obtained (that is, the position information E1 (xe1, ye1, ze1) of the user first eye E1 and the position information (xe2, ye2, ze2) of the user second eye E2 are obtained).

In an exemplary embodiment, according to the position information of N user eyes in real time, the N pixel correspondences under N angles of view corresponding to the position information of N user eyes may be calculated. Then, act 302 may include the following acts.

In act 3021, the N pixel correspondences corresponding to the position information of N user eyes one-to-one are determined based on the position information of N user eyes, the position information of each pixel in the liquid crystal display panel, the position information of each pixel in the light control panel, and a gap thickness between the light control panel and the liquid crystal display panel. Here, the pixel correspondence corresponding to the position information of each user eye is a correspondence between the pixels in the light control panel and the pixels in the liquid crystal display panel under the angle of view corresponding to the position information of the user eye.

In another exemplary embodiment, the act S3021 may include acts S3021a to S3021b.

In act 3021a, N sets of projection position information corresponding to the position information of N user eyes one-to-one are calculated according to the position information of N user eyes, the position information of each pixel in the liquid crystal display panel and the gap thickness between the light control panel and the liquid crystal display panel. A set of projection position information corresponding to the position information of each user eye includes: position information of projections of all pixels in the liquid crystal display panel on the light control panel under an angle of view corresponding to the position information of the user eye.

In act 3021b, projection composition is performed on the N sets of projection position information corresponding to the position information of the N user eyes one-to-one and the position information of each pixel in the light control panel to obtain the N pixel correspondences corresponding to the position information of the N user eyes one-to-one.

In an exemplary embodiment, taking the liquid crystal display panel including p rows and q columns of first pixels and the light control panel including p rows and q columns of second pixels in as an example, a kth set of projection position information corresponding to the position information of a kth user eye may be calculated according to the following formulas (1) and (2) (i.e., under a kth angle of view corresponding to the position information of the kth user eye, position information of projection of a pixel MC_{i,j} in the liquid crystal display panel on the light control panel).

$$\begin{matrix}x t {c}_{i , j , k} = \frac{( {xmc}_{i , j} - x {e}_{k} ) \times ( zm {c}_{i , j} - {ze}_{k} )}{zm {c}_{i , j} - z {e}_{k} + d} + x {e}_{k} ; & Formula ( 1 ) \\ {ytc}_{i , j , k} = \frac{( {ymc}_{i , j} - x {e}_{k} ) \times ( zm {c}_{i , j} - {ze}_{k} )}{zm {c}_{i , j} - z {e}_{k} + d} + x {e}_{k} ; & Formula ( 2 )\end{matrix}$$

where, (xtc_{i,j,k}, ytc_{i,j,k}) represents position information of projection of a pixel MC_{i,j} in an ith row and a jth column in the liquid crystal display panel on the light control panel under a kth angle of view corresponding to position information of a kth user eye; (xmc_{i,j}, ymc_{i,j}, zmc_{i,j}) represents position information of the pixel MC_{i,j} in the ith row and the jth column in the liquid crystal display panel; (xeₖ, yeₖ, zeₖ) represents the position information of the kth user eye; d represents a gap thickness between the light control panel and the liquid crystal display panel; i is a positive integer greater than or equal to 1 and smaller than or equal to p, j is a positive integer greater than or equal to 1 and smaller than or equal to q, p and q are positive integers, and k is a positive integer smaller than or equal to N.

For example, taking the kth set of projection position information corresponding to the position information of the kth user eye including position information of projection of a pixel MC_{2,2} in a second row and a second column in the liquid crystal display panel on the light control panel and position information of projection of a pixel MC_{2,1} in the second row and a first column in the liquid crystal display panel on the light control panel as an example, assuming that projection composition is performed on position information of projection of the pixel MC_{2,2} in the second row and the second column in the liquid crystal display panel on the light control panel and position information of projection of the pixel MC_{2,1} in the second row and a first column in the liquid crystal display panel on the light control panel and position information of each pixel in the light control panel, the following projection composition results may be obtained.

Projection composition result 1: 30% of a projection area of the pixel MC_{2,2} in the second row and the second column in the liquid crystal display panel is located at the pixel SC_{2,1} in a second row and a first column in the light control panel, and 70% of a projection area of the pixel MC_{2,2} in the second row and the second column in the liquid crystal display panel is located at a pixel SC_{2,2} in a second row and a second column in the light control panel. That is to say, the pixel SC_{2,1} in the second row and the first column in the light control panel corresponds to 30% of the area of the pixel MC_{2,2} in the second row and the second column in the liquid crystal display panel, and the pixel SC_{2,2} in the second row and the second column in the light control panel corresponds to 70% of the area of the pixel MC_{2,2} in the second row and the second column in the liquid crystal display panel.

Projection composition result 2: 70% of a projection area of the pixel MC_{2,1} in the second row and the first column in the liquid crystal display panel is located at the pixel SC_{2,1} in the second row and the first column in the light control panel, that is to say, the pixel SC_{2,1} in the second row and the first column in the light control panel corresponds to 70% of the projection area of the pixel MC_{2,1} in the second row and the first column in the liquid crystal display panel.

By combining the projection composition result 1 and the projection composition result 2, a sub-pixel correspondence (or which is referred as to a sub-projection transition matrix) corresponding to the pixel SC_{2,1} in the second row and the first column in the light control panel under the angle of view corresponding to the position information of the kth user eye may be obtained as follows: the pixel SC_{2,1} in the second row and the first column in the light control panel corresponds to 70% of the projection area of the pixel MC_{2,1} in the second row and the first column in the liquid crystal display panel, and corresponds to 30% of the area of the pixel MC_{2,2} in the second row and the second column in the liquid crystal display panel.

Thus, the sub-pixel correspondence Tₖ(2,1) (or which is referred as to the sub-projection transition matrix) corresponding to the pixel SC_{2,1} in the second row and the first column in the light control panel under the angle of view corresponding to the position information of the kth user eye may be expressed by the following formula (3):

$${T}_{k} ( 2 , 1 ) = [ \begin{matrix}0 & 0 & … & 0 \\ 0.7 & 0.3 & … & 0 \\ ⋮ & ⋮ & ⋱ & ⋮ \\ 0 & 0 & … & 0\end{matrix} ] . \qquad Formula ( 3 )$$

Similarly, a sub-pixel correspondence (or which is referred as to a sub-projection transition matrix) corresponding to each pixel in the light control panel under the angle of view corresponding to the position information of the kth user eye may be obtained, and thus the pixel correspondence under the kth angle of view corresponding to the position information of the kth user eye may be obtained.

In an exemplary embodiment, act 303 may include the following acts 3031 to 3032.

In act 3031, N grayscale data to be processed corresponding to the N pixel correspondences one-to-one are obtained according to the original grayscale data and the N pixel correspondences corresponding to the position information of N user eyes one-to-one.

In act 3032, the target grayscale data is determined based on the N grayscale data to be processed corresponding to the N pixel correspondences one-to-one.

Below an example will be given to explain how to obtain N grayscale data to be processed corresponding to N pixel correspondences one-to-one.

Taking the liquid crystal display panel including p rows and p columns of pixels and the light control panel including p rows and q columns of pixels as an example, after N pixel correspondences corresponding to the position information of N user eyes one-to-one are obtained, for a pixel correspondence corresponding to position information of each user eye, the grayscale data corresponding to the pixel correspondence corresponding to the position information of the user eye is calculated based on the pixel correspondence corresponding to the position information of the user eye and the original grayscale data by the following formulas (4) to (9).

$$I M {G}_{0} = [ \begin{matrix}{x}_{1 , 1} & … & {x}_{1 , q} \\ ⋮ & ⋱ & ⋮ \\ {x}_{p , 1} & … & {x}_{p , q}\end{matrix} ] \qquad Formula ( 4 )$$

Where IMG₀ represents the original grayscale data; x_{1,1} represents an original sub-grayscale value corresponding to a pixel in a first row and a first column; x_{1,q} represents an original sub-grayscale value corresponding to a pixel in the first row and a qth column; x_{p,1} represents an original sub-grayscale value corresponding to a pixel in a pth row and a first column; x_{p,q} represents an original sub-grayscale value corresponding to a pixel in row p and column q; and p and q are positive integers.

$${T}_{k} = [ \begin{matrix}{T}_{k} ( 1 , 1 ) & … & {T}_{k} ( 1 , q ) \\ ⋮ & ⋱ & ⋮ \\ {T}_{k} ( p , 1 ) & … & {T}_{k} ( p , q )\end{matrix} ] \qquad Formula ( 5 )$$

Where Tₖ represents the pixel correspondence corresponding to the position information of the kth user eye (i.e., the kth pixel correspondence); Tₖ(1,1) represents a sub-pixel correspondence (or which is referred as to a sub-projection transfer matrix) corresponding to a pixel in a first row and a first column in the light control panel under the angle of view corresponding to the position information of the kth user eye; Tₖ(1, q) represents a sub-pixel correspondence corresponding to a pixel in the first row and a q column in the light control panel under the angle of view corresponding to the position information of the kth user eye; Tₖ(p,1) represents a sub-pixel correspondence corresponding to a pixel in a pth row and the first column in the light control panel under the angle of view corresponding to the position information of the kth user eye; Tₖ(p,q) represents a sub-pixel correspondence corresponding to a pixel in the pth row and a qth column in the light control panel under the angle of view corresponding to the position information of the kth user eye; p and q are positive integers; k is a positive integer smaller than or equal to N.

$$I M {G}_{k} = [ \begin{matrix}{N}_{k} ( 1 , 1 ) & … & {N}_{k} ( 1 , q ) \\ ⋮ & ⋱ & ⋮ \\ {N}_{k} ( p , 1 ) & … & {N}_{k} ( p , q )\end{matrix} ] \qquad Formula ( 6 )$$

Where, IMGₖ represents the grayscale data corresponding to the kth pixel correspondence (i.e., kth grayscale data); Nₖ(1,1) represents a sub-grayscale value corresponding to the pixel in the first row and the first column in the light control panel under the angle of view corresponding to the position information of the kth user eye; Tₖ(1,q) represents a sub-grayscale value corresponding to the pixel in the first row and the qth column in the light control panel under the angle of view corresponding to the position information of the kth user eye; Tₖ(p,1) represents a sub-grayscale value corresponding to the pixel in the pth row and the first column in the light control panel under the angle of view corresponding to the position information of the kth user eye; Tₖ(p,q) represents a sub-grayscale value corresponding to the pixel in the pth row and the qth column in the light control panel under the angle of view corresponding to the position information of the kth user eye; p and q are positive integers; k is a positive integer smaller than or equal to N.

For example, under the angle of view corresponding to the position information of the kth user eye, the sub-pixel correspondence (the sub-projection transition matrix) corresponding to the pixel SC_{2,1} in the second row and the first column in the light control panel is as follows: the pixel SC_{2,1} in the second row and the first column in the light control panel corresponds to 70% of the projection area of the pixel MC_{2,1} in the second row and the first column in the liquid crystal display panel, and 30% of the area of the pixel MC_{2,2} in the second row and the second column in the liquid crystal display panel. Thereby, the grayscale value corresponding to the pixel SC_{2,1} in the second row and the first column in the light control panel may be equal to 70% of the grayscale value of the pixel MC_{2,1} in the second row and the first column in the liquid crystal display panel plus 30% of the grayscale value of the pixel MC_{2,2} in the second row and the second column in the liquid crystal display panel. (i.e., Nₖ(2,1)=Sum(Tₖ(2,1)×IMG₀)).

That is to say, the sub-pixel correspondence Tₖ(i,j) (or which is referred as the sub-projection transfer matrix) corresponding to a pixel in an ith row and a jth column in the light control panel under the angle of view corresponding to the position information of the kth user eye as shown in formula (7) crosses the original grayscale data IMG₀ as shown in formula (4), and then the sum of the cross product is calculated, as shown in formula (8) a grayscale value to be processed Nₖ(i,j) corresponding to the pixel in the ith row and the jth column in the light control panel under the angle of view corresponding to the position information of the kth user eye is obtained.

$${T}_{k} ( i , j ) = [ \begin{matrix}{t}_{1 , 1} & … & {t}_{1 , q} \\ ⋮ & ⋱ & ⋮ \\ {t}_{p , 1} & … & {t}_{p , q}\end{matrix} ] \qquad Formula ( 7 )$$

Where, Tₖ(i,j) represents the sub-pixel correspondence (or which is referred as to the sub-projection transition matrix) corresponding to the pixel in the ith row and jth column in the light control panel under the angle of view corresponding to the position information of the kth user eye; t_{1,1} represents a correspondence between the pixel in the ith row and the jth column in the light control panel and a pixel in a first row and a first column in the liquid crystal display panel under the angle of view corresponding to the position information of the kth user eye; t_{1,q} represents a correspondence between the pixel in the ith row and the jth column in the light control panel and a pixel in the first row and a qth column in the liquid crystal display panel under the angle of view corresponding to the position information of the kth user eye; p_{p,1} represents a correspondence between the pixel in the ith row and the jth column in the light control panel and a pixel in a pth row and the first column in the liquid crystal display panel under the angle of view corresponding to the position information of the kth user eye; t_{p,q} represents a correspondence between the pixel in the ith row and the jth column in the light control panel and a pixel in the pth row and the qth column in the liquid crystal display panel under the angle of view corresponding to the position information of the kth user eye; i is a positive integer greater than or equal to 1 and smaller than or equal to p, j is a positive integer greater than or equal to 1 and smaller than or equal to q, and p and q are positive integers; k is a positive integer smaller than or equal to N.

$${N}_{k} ( i , j ) = S u m ( {T}_{k} ( i , j ) \times I M {G}_{0} ) = Sum ( [ \begin{matrix}{t}_{1 , 1} & … & {t}_{1 , q} \\ ⋮ & ⋱ & ⋮ \\ {t}_{p , 1} & … & {t}_{p , q}\end{matrix} ] \times [ \begin{matrix}{x}_{1 , 1} & … & {x}_{1 , q} \\ ⋮ & ⋱ & ⋮ \\ {x}_{p , 1} & … & {x}_{p , q}\end{matrix} ] ) \qquad Formula ( 8 )$$

Where, Nₖ(i,j) represents a grayscale value to be processed corresponding to the pixel in the ith row and the jth column in the light control panel under the angle of view corresponding to the position information of the kth user eye; Sum (·) represents summation; Tₖ(i,j) represents the correspondence (or which is referred to as the sub-projection transfer matrix) corresponding to the pixel in the ith row and jth column in the light control panel under the angle of view corresponding to the position information of the kth user eye; IMG₀ represents the original grayscale data; i is a positive integer greater than or equal to 1 and smaller than or equal to p, j is a positive integer greater than or equal to 1 and smaller than or equal to q, and p and q are positive integers; k is a positive integer less than or equal to N.

Similarly, the grayscale values to be processed corresponding to other pixels in the light control panel may be obtained. Therefore, the kth grayscale data to be processed IMGₖ shown in the following formula (9) may be obtained.

$$IM {G}_{k} = [ \begin{matrix}{N}_{k} ( 1 , 1 ) & … & {N}_{k} ( 1 , q ) \\ ⋮ & ⋱ & ⋮ \\ {N}_{k} ( p , 1 ) & … & {N}_{k} ( p , q )\end{matrix} ] = [ \begin{matrix}Sum ( {T}_{k} ( 1 , 1 ) \times IM {G}_{0} ) & … & Sum ( {T}_{k} ( 1 , q ) \times IM {G}_{0} ) \\ ⋮ & ⋱ & ⋮ \\ Sum ( {T}_{k} ( p , 1 ) \times {IMG}_{0} ) & … & Sum ( {T}_{k} ( p , q ) \times IM {G}_{0} )\end{matrix} ] \qquad Formula ( 9 )$$

Where IMGₖ represents the grayscale data to be processed corresponding to the kth pixel correspondence; Sum (·) represents summation; IMG₀ represents the original grayscale data; Nₖ(1,1) represents a grayscale value to be processed corresponding to the pixel in the first row and the first column in the light control panel under the angle of view corresponding to the position information of the kth user eye; Nₖ(1,q) represents a grayscale value to be processed corresponding to the pixel in the first row and the qth column in the light control panel under the angle of view corresponding to the position information of the kth user eye; Nₖ(p,1) represents a grayscale value to be processed corresponding to the pixel in the pth row and the first column in the light control panel under the angle of view corresponding to the position information of the kth user eye; Nₖ(p,q) represents a grayscale value to be processed corresponding to the pixel in the pth row and the qth column in the light control panel under the angle of view corresponding to the position information of the kth user eye; Tₖ(1,1) represents a sub-pixel correspondence corresponding to the pixel in the first row and the first column in the light control panel under the angle of view corresponding to the position information of the kth user eye; Tₖ(1,q) represents a sub-pixel correspondence corresponding to the pixel in the first row and the qth column in the light control panel under the angle of view corresponding to the position information of the kth user eye; Tₖ(p,1) represents a sub-pixel correspondence corresponding to the pixel in the pth row and the first column in the light control panel under the angle of view corresponding to the position information of the kth user eye; Tₖ(p,q) represents a sub-pixel correspondence corresponding to the pixel in the pth row and the qth column in the light control panel under the angle of view corresponding to the position information of the kth user eye; p and q are positive integers; k is a positive integer smaller than or equal to N.

In another exemplary embodiment, act 3032 may include the following acts 3032a to 3032b.

In act 3032a, the N grayscale data to be processed are superposed to calculate processed grayscale data.

In act 3032b, the processed grayscale data is taken as the target grayscale data.

In another exemplary embodiment, act 3032 may include acts 3032c to 3032e.

In act 3032c, the N grayscale data to be processed are superposed to calculate processed grayscale data.

In act 3032d, the processed grayscale data is smoothed to obtain smoothed grayscale data.

In act 3032e, the smoothed grayscale data is taken as the target grayscale data.

In an exemplary embodiment, act 3032a or act 3032c may include: after obtaining N grayscale data to be processed corresponding to N pixel correspondences one-to-one, processed grayscale data is calculated according to the following formula (10):

IMG=MAX(IMG₁,IMG₂, . . . ,IMG_{N}) Formula (10)

Where, IMG represents the processed grayscale data, IMG₁ represents a first grayscale data to be processed, IMG₂ represents a second grayscale data to be processed, IMG_{N} represents an Nth grayscale data to be processed, and MAX (·) represents a matrix composed of larger elements among elements corresponding to the N grayscale data to be processed.

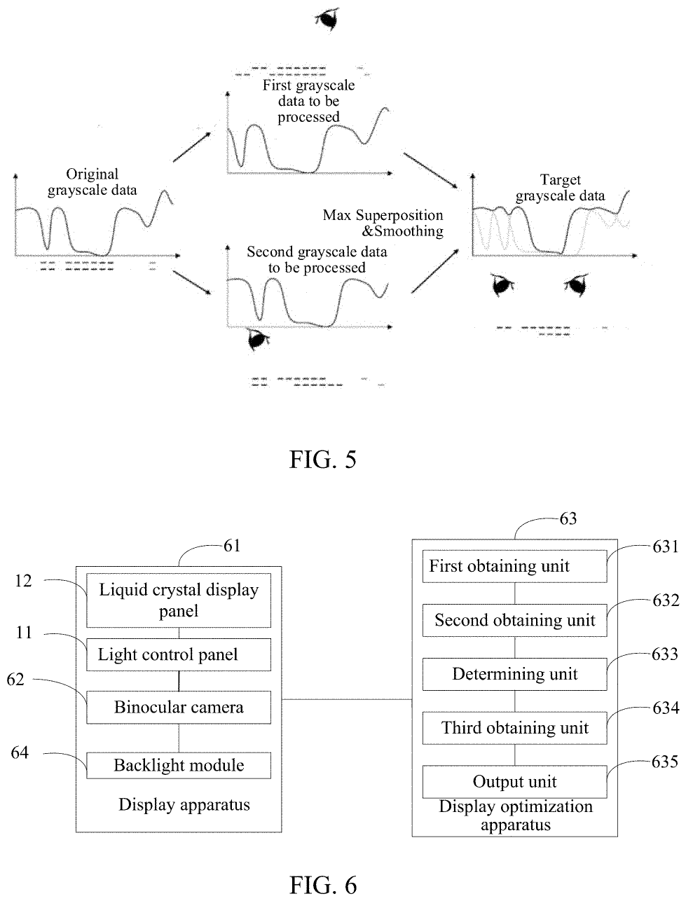

For example, as shown in FIG. 5, first grayscale data to be processed is obtained according to a pixel correspondence corresponding to the position information of a first user eye and the original grayscale data, and second grayscale data to be processed is obtained according to a pixel correspondence corresponding to the position information of a second user eye and the original grayscale data. Next, the first grayscale data to be processed and the second grayscale data to be processed are superposed (i.e., grayscale maximization processing) and smoothed to obtain the target grayscale data. Here, for the sake of intuition, in FIG. 5, the grayscale data of the image is represented as a waveform.

In an exemplary embodiment, act 3032d may include smoothing the processed grayscale data by any one of an image mean smoothing filtering, a Gaussian filtering and a median filtering to obtain smoothed grayscale data.

As can be seen from the above, according to the display method provided by the embodiment of the present disclosure, the pixel correspondence between the pixels in the light control panel and the pixels in the liquid crystal display panel under the angle of view corresponding to the position information of the user eye is determined based on the position information of the user eye, and the target grayscale data of the light control panel is determined according to the pixel correspondence. Therefore, since the target grayscale data is a display image of the light control panel without ghosting under multiple angles of view, when the original grayscale data is output to the liquid crystal display panel and the target grayscale data is output to the light control panel to perform display, the content displayed by pixels in the liquid crystal display panel and the content displayed by pixels in the light control panel will not be non-coincided under the angle of view corresponding to the position information of the user eye, so that the user can view the display panel at any angle without the ghosting problem. In addition, there is no evident halo and the contrast is ensured. Therefore, the display effect is improved, and the visual experience of users is improved.

An embodiment of the present disclosure provides an electronic device. FIG. 6 is a schematic diagram of a structure of an electronic device according to an embodiment of the present disclosure. As shown in FIG. 6, the electronic device may include a display apparatus 61, a binocular camera 62 and a display optimization apparatus 63.

The display apparatus 61 includes a light control panel 11 and a liquid crystal display panel 12 located on a light-emitting side of the light control panel 11.

The binocular camera 62 is configured to capture a first image and a second image.

The display optimization apparatus 63 may include: a first obtaining unit 631, a second obtaining unit 632, a determining unit 633, a third obtaining unit 634 and an output unit 635.

The first obtaining unit 631 is configured to obtain position information of N user eyes based on position information of the binocular camera, the first image and the second image; where N is a positive integer greater than 1.

The second obtaining unit 632 is configured to obtain original grayscale data of an image to be displayed.

The determining unit 633 is configured to determine N pixel correspondences corresponding to the position information of the N user eyes one-to-one based on the position information of the N user eyes, wherein pixel correspondence corresponding to position information of each user eye is a correspondence between pixels in a light control panel and pixels in a liquid crystal display panel under an angle of view corresponding to the position information of the user eye.

The third obtaining unit 634 is configured to adjust the original grayscale data according to the N pixel correspondences to obtain target grayscale data.

The output unit 635 is configured to output the original grayscale data to the liquid crystal display panel 12 and output the target grayscale data to the light control panel 11.

In an exemplary embodiment, as shown in FIG. 6, the display apparatus may further include a backlight module 64 disposed on a side of the light control panel 11 away from the liquid crystal display panel 12.

In an exemplary embodiment, the binocular camera may be integrated with or separated from the display apparatus physically, and the embodiments of the present disclosure are not limited to this.

In an exemplary embodiment, as shown in FIG. 6, taking the binocular camera being integrated with the display apparatus as an example, the binocular camera 62 is disposed between the backlight module 64 and the light control panel 11 (i.e., disposed on a side of the backlight module 64 close to the light control panel).

In an exemplary embodiment, the binocular camera may be an infrared camera.

In an exemplary embodiment, taking the binocular camera being an infrared camera and being integrated with the display apparatus as an example, the display apparatus also includes a backlight module disposed on a side of the light control panel away from the liquid crystal display panel, and the binocular camera is the infrared camera disposed between the backlight module and the light control panel.

In an exemplary embodiment, taking the binocular camera being an infrared camera and being integrated with the display apparatus as an example, the backlight module may include: a light source assembly configured to supply an initial backlight to the light control panel; and a plastic frame including a bearing part disposed to bear and fix the light control panel, wherein the infrared camera is disposed on a side of the bearing part away from the light control panel.

Below, a structure of a display apparatus according to an embodiment of the present disclosure will be described by taking the binocular camera being integrated with the display apparatus and disposed on a side of the bearing part away from the light control panel as an example.

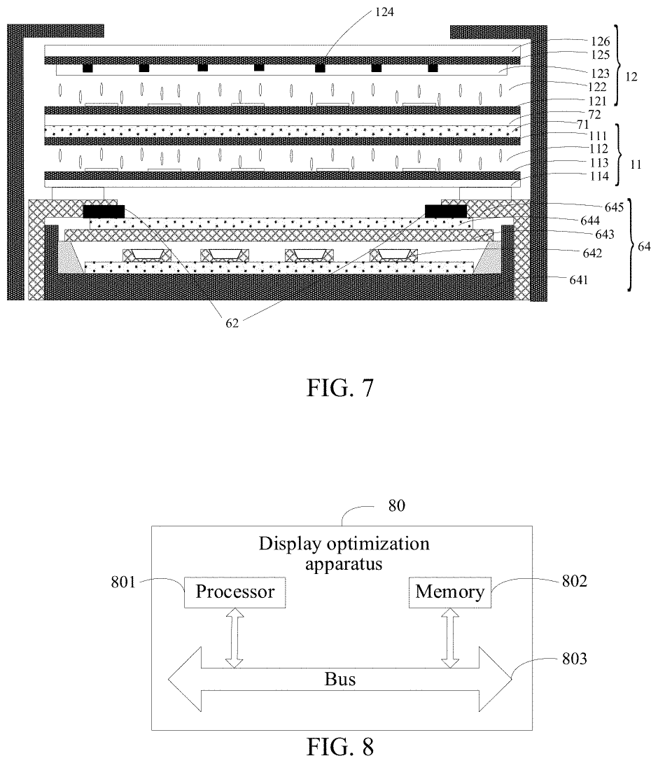

FIG. 7 is a diagram of another structure of a display apparatus according to an embodiment of the present disclosure. As shown in FIG. 7, the display apparatus 61 may include a backlight module 64, a light control panel 11 located on a light-emitting side of the backlight module 64, and a liquid crystal display panel 12 located on a light-emitting side of the light control panel 11. The display apparatus 61 may further include a binocular camera 62 disposed between the backlight module 64 and the light control panel 11.

The backlight module 64 is configured to supply an initial backlight to the light control panel 11. The light control panel 11 is configured to regulate the initial backlight based on the target grayscale data output by the display optimization apparatus 63 and supply the regulated backlight to the liquid crystal display panel 12. The liquid crystal display panel 12 is configured to receive the regulated backlight and display based on the original grayscale data output by the display optimization apparatus 63. The binocular camera is configured to capture a first image and a second image.

In an exemplary embodiment, the display apparatus provided by the embodiment of the present disclosure may be a liquid crystal display apparatus or other apparatus with a display function.

In an exemplary embodiment, the light control panel may be a light control liquid crystal panel or other types of panels with a light control function, such as an electronic ink panel or an electrochromic panel.

In an exemplary embodiment, a brightness of the backlight supplied to the liquid crystal display panel may be controlled in different regions through the light control panel disposed between the liquid crystal display panel and the backlight module. For example, the light control panel is usually a light control liquid crystal panel, and may regulate the brightness of the backlight supplied to the liquid crystal display panel by regulating deflection angles of liquid crystal molecules in a liquid crystal layer of the light control liquid crystal panel. For example, the brightness of the backlight supplied to part of the liquid crystal display panel corresponding to a dark state region of the display image may be reduced by regulating the deflection angles of liquid crystal molecules in the light control liquid crystal panel, so as to reduce transmitted light intensity of the dark state region of the display image, thereby avoiding or weakening the dark state light leakage phenomenon of the liquid crystal display apparatus.

In an exemplary embodiment, the liquid crystal display panel and the light control panel have the same appearance size and functional size. For example, the liquid crystal display panel and the light control panel have the same shape and size, a display region in the liquid crystal display panel and a light control region in the light control panel have the same shape and size, so that after the liquid crystal display panel and the light control panel are aligned and bonded, the light control region may correspond to the display region, thereby the backlight emitted by the backlight module after the backlight is regulated in the light control region is provided to the display area. For example, the display region in the liquid crystal display panel includes a plurality of display pixels; the light control region in the light control panel includes a plurality of light control pixels.

In an exemplary embodiment, the light control panel may be a black-and-white liquid crystal display panel without a color filter. Alternatively, the light control panel may be a white organic electroluminescent display panel.

In an exemplary embodiment, as shown in FIG. 7, the liquid crystal display panel 12 may include a first substrate 121, a first liquid crystal layer 122, color filter layers 123, a black matrix layer 124, a second substrate 125 and an upper polarizer 126.

The first liquid crystal layer 122 is disposed on a side of the first substrate 121 away from the light control panel 11.

The color filter layers 123 are disposed on a side of the first liquid crystal layer 122 away from the first substrate 121.

The black matrix layer 124 is disposed between the color filter layers 123 and is disposed on the same layer as the color filter layers 123.

The second substrate 125 is disposed on a side of the color filter layers 123 away from the first liquid crystal layer 122.

The upper polarizer 126 is disposed on a side of the second substrate 125 away from the color filter layers 123.

In an exemplary embodiment, as shown in FIG. 7, the light control panel 11 may include a third substrate 111, a second liquid crystal layer 112, a fourth substrate 113 and a lower polarizer 114.

The second liquid crystal layer 112 is disposed on a side of the third substrate 111 away from the liquid crystal display panel 12.

The fourth substrate 113 is disposed on a side of the second liquid crystal layer 112 away from the third substrate 111.

The lower polarizer 114 is disposed on a side of the fourth substrate 113 away from the second liquid crystal layer 112.

In an exemplary embodiment, the display apparatus may further include an adhesive layer 71 and an intermediate polarizer 72.

The adhesive layer 71 is disposed on a side of the third substrate 111 close to the liquid crystal display panel 12.

The intermediate polarizer 72 is disposed on a side of the adhesive layer 71 away from the third substrate 111.

Here, the liquid crystal display panel and the light control panel are adhered together by an intermediate adhesive layer, and three polarizers (i.e., an upper polarizer, an intermediate polarizer and a lower polarizer) are disposed in the display apparatus.

In an exemplary embodiment, as shown in FIG. 7, the display apparatus may further include a backlight module 64 disposed on a backlight side of the light control panel 11 (i.e., a side of the light control panel 11 away from the liquid crystal display panel 12).

In an exemplary embodiment, as shown in FIG. 7, the backlight module 64 may include a back plate 641, a light source assembly 642, a diffusion plate 643, an optical assembly 644 and a plastic frame 645.

The light source assembly 642 is disposed on a side of the back plate 641 close to the light control panel 11, and is configured to generate an initial backlight and supply the initial backlight to the light control panel 11.

The diffusion plate 643 is disposed on a side of the light source assembly 642 away from the back plate 641 (i.e., on a light-emitting side of the light source assembly 642).

The optical assembly 644 is disposed on a side of the diffusion plate 643 away from the light source assembly 642 (i.e., on the light-emitting side of the light source assembly 642).

The plastic frame 645 is disposed on a side of the optical assembly 644 away from the light source assembly 642 (i.e., on the light-emitting side of the light source assembly 642). The plastic frame 645 may include a bearing part arranged to bear and fix the light control panel and a supporting part connected with the bearing part, the bearing part extends in a plane parallel to the light control panel and the supporting part extends in a plane perpendicular to the light control panel.

The binocular camera 62 (for example, an infrared camera) is disposed on a side of the bearing part away from the light control panel 11.

Here, taking the binocular camera being an infrared camera as an example, the binocular camera may include two functions of transmitting and receiving infrared rays. The main reason for arranging the binocular camera on a lower side of the plastic frame is that there is not too many optical films (haze) on an upper side of this position, which will affect capturing of camera images, and the polarizer has good transmittance for infrared wavelengths (>780 nm). Moreover, the infrared band generated by the backlight module is less, and the infrared camera is not easy to be disturbed. In addition, the reflection of infrared rays by eyes is better. Therefore, the accuracy of the position information of the user eyes can be improved.

In an exemplary embodiment, the light source assembly includes a plurality of light sources, such as a plurality of line light sources or a plurality of point light sources, for example, the point light sources may be Light Emitting Diode (LED) light sources, and the line light sources may be Cold Cathode Fluorescent Lamp (CCFL) light sources, etc. For example, the light source assembly may be a direct type backlight or a side-in type backlight, and the side-in type backlight also includes a light guide plate.

In an exemplary embodiment, the optical assembly may include an optical functional film such as a prism film.

In addition, the above-mentioned display apparatus may also include other structures or film layers. For example, as shown in FIG. 7, the display apparatus may further include a front frame 73 and a rubber layer 74, which is not limited by the embodiments of the present disclosure. For example, in an exemplary embodiment, the binocular camera may be disposed in the front frame. For example, the liquid crystal display panel may include various components for display such as gate lines, data lines, pixel electrodes, common electrodes. Similarly, the light control panel may include various components for realizing light control, such as gate lines, data lines, pixel electrodes, and common electrodes.

In an exemplary embodiment, the display apparatus may be any product or component with a display function such as a mobile phone, a tablet computer, a television, a display, a notebook computer, a digital photo frame, a navigator. Other essential components included by the display apparatus which should be understood by those of ordinary skill in the art will not be described repeatedly herein, and should not be regarded as a limitation to the present disclosure.

As can be seen from the above, the electronic device provided by the embodiment of the disclosure, combined with the filtering characteristics of the polarizer, achieves an integrated effect by disposing the infrared camera between the display panel and the backlight module. Since the user eyes have better reflection on infrared rays, it is easier to identify the positions of the user eyes, so that more accurate position information of the user eyes can be obtained. Furthermore, more accurate pixel correspondences between pixels in the light control panel and pixels in the liquid crystal display panel under the angle of view corresponding to the position information of the user eyes can be obtained through more accurate position information of the user eyes. Then, more accurate target grayscale data of the light control panel can be determined according to the more accurate pixel correspondences. Therefore, since the target grayscale data is a display image of the light control panel without ghosting under multiple angels of view, when the original grayscale data is output to the liquid crystal display panel and the target grayscale data is output to the light control panel to perform display, the content displayed by pixels in the liquid crystal display panel and the content displayed by pixels in the light control panel will not be non-coincided under the angle of view corresponding to the position information of the user eye, so that the user can view the display panel at any angle without the ghosting problem. In addition, there is no evident halo and the contrast is ensured. Therefore, the display effect is improved, and the visual experience of users is improved.

In an exemplary embodiment, the present disclosure also provides a display optimization apparatus. The display optimization apparatus may include a processor and a memory storing a computer program that may be run on the processor, the acts of the display method in one or more embodiments described above are implemented when the processor executes the program.

In an exemplary embodiment, as shown in FIG. 8, the display optimization apparatus 80 may include at least one processor 801, at least one memory 802 connected to the processor 801, and bus 803. The processor 801 and the memory 802 communicate with each other through the bus 803. The processor 801 is configured to call program instructions in the memory 802 to execute the acts of the display method in one or more embodiments described above.

In practice, the above-mentioned processor may be a central processing unit (CPU), other general-purpose processors, a digital signal processor (DSP), a field programmable gate array (FPGA) or other programmable logic devices, a discrete gate or transistor logic device, a discrete hardware component, an application specific integrated circuit, etc. The general-purpose processor may be a microprocessor (MPU) or any conventional processor.

The memory may include a volatile memory, a random access memory (RAM) and/or a nonvolatile memory in computer readable storage media, such as a read only memory (ROM) or flash RAM, and the memory includes at least one memory chip.

Besides a data bus, a bus may also include a power bus, a control bus and a status signal bus, etc. However, for clarity of illustration, each bus is denoted as the bus 803 in FIG. 8.

In an implementation process, the processing performed by the display optimization apparatus may be completed by an integrated logic circuit of hardware in the processor or instructions in the form of software. That is, the acts of the method in the embodiments of the present disclosure may be embodied as the execution of hardware processor, or the execution of a combination of hardware in the processor and software modules. The software modules may be located in a storage medium, such as a random access memory, a flash memory, a read-only memory, a programmable read-only memory, an electrically erasable programmable memory, or a register. The storage medium is located in the memory, and the processor reads information in the memory and completes the acts of the foregoing methods in combination with hardware thereof. To avoid repetition, the detail will not be described here.

In an embodiment of the present disclosure, the present disclosure further provides a non-transient computer readable storage medium, which includes a stored program, wherein a device where the storage medium is located is controlled to execute acts of the display method in one or more embodiments described above when the program is run.

In practice, the computer readable storage medium described above may be, for example, a ROM/RAM, magnetic disk, optical disk, etc.

The above description of the embodiments of the display optimization apparatus, the electronic device or computer readable storage medium is similar to the description of the above description of method embodiments, and has similar advantages. For the technical details not disclosed in the embodiments of the display optimization apparatus, the electronic device or computer readable storage medium of the present disclosure, please refer to the description of the method embodiments of the method, which will not be described here repeatedly.

Those of ordinary skill in the art may understand that all or some of the acts in the method, the system, and functional modules/units in the apparatus disclosed above may be implemented as software, firmware, hardware, and an appropriate combination thereof. In a hardware implementation, the division between functional modules/units mentioned in the above description does not necessarily correspond to the division of physical components. For example, a physical component may have multiple functions, or a function or an act may be performed by several physical components in cooperation. Some or all of the components may be implemented as software executed by a processor, such as a digital signal processor or a microprocessor, or as hardware, or as an integrated circuit, such as an application specific integrated circuit. Such software may be distributed on a computer readable medium, which may include a computer storage medium (or a non-transitory medium) and a communication medium (or a transitory medium). As is well known to those of ordinary skill in the art, the term “computer storage medium” includes volatile and nonvolatile, removable and non-removable media implemented in any method or technology for storing information (such as computer readable instructions, a data structure, a program module or other data). The computer storage medium includes, but is not limited to, a Random Access Memory (RAM), Read Only Memory (ROM), EEPROM, Flash RAM or other memory technologies, CD-ROM, digital versatile disk (DVD) or other optical disk storages, a magnetic box, magnetic tape, magnetic disk storage or other magnetic storage devices, or any other media that may be used to store desired information and may be accessed by computers. Furthermore, it is well known to those of ordinary skill in the art that the communication medium typically contains computer readable instructions, a data structure, a program module, or other data in a modulated data signal such as a carrier or another transmission mechanism, and may include any information delivery medium.

Although the embodiments disclosed in the present disclosure are as described above, the embodiments described in the above contents are only for understanding easily the present disclosure, not for limiting the present disclosure. Any person skilled in the art to which the present disclosure pertains may make any modifications and variations in the form and details of implementations without departing from the spirit and the scope disclosed by the present disclosure, but the protection scope of the present disclosure shall still be subject to the scope defined in the appended claims.

1. A display method, applied to a display apparatus comprising a light control panel and a liquid crystal display panel which are stacked, the method comprising:
obtaining position information of N user eyes and original grayscale data of an image to be displayed, wherein N is a positive integer greater than 1;
determining N pixel correspondences corresponding to the position information of the N user eyes one-to-one based on the position information of the N user eyes, wherein a pixel correspondence corresponding to position information of each user eye is a correspondence between pixels in the light control panel and pixels in the liquid crystal display panel under an angle of view corresponding to the position information of the user eye;
adjusting the original grayscale data according to the N pixel correspondences to obtain target grayscale data; and
outputting the original grayscale data to the liquid crystal display panel and outputting the target grayscale data to the light control panel to perform display.

2. The display method according to claim 1, wherein the determining N pixel correspondences corresponding to the position information of the N user eyes one-to-one based on the position information of the N user eyes comprises:
determining the N pixel correspondences based on the position information of the N user eyes, position information of each pixel in the liquid crystal display panel, position information of each pixel in the light control panel and a gap thickness between the light control panel and the liquid crystal display panel.

3. The display method according to claim 2, wherein the determining N pixel correspondences comprises:
calculating projection position information corresponding to the position information of the N user eyes according to the position information of the N user eyes, the position information of each pixel in the liquid crystal display panel, and the gap thickness between the light control panel and the liquid crystal display panel, wherein projection position information corresponding to the position information of each user eye is position information of projection of each pixel in the liquid crystal display panel on the light control panel under the angle of view corresponding to the position information of the user eye; and
performing projection composition on the projection position information corresponding to the position information of the N user eyes and the position information of each pixel in the light control panel respectively to obtain the N pixel correspondences.

4. The display method according to claim 3, wherein the calculating the projection position information corresponding to the position information of the N user eyes comprises:
calculating projection position information corresponding to position information of a kth user eye according to the following formula:
$$\begin{matrix}x t {c}_{i , j , k} = \frac{( {xmc}_{i , j} - x {e}_{k} ) \times ( zm {c}_{i , j} - {ze}_{k} )}{zm {c}_{i , j} - z {e}_{k} + d} + x {e}_{k} ; \\ {ytc}_{i , j , k} = \frac{( {ymc}_{i , j} - x {e}_{k} ) \times ( zm {c}_{i , j} - {ze}_{k} )}{zm {c}_{i , j} - z {e}_{k} + d} + x {e}_{k} ;\end{matrix}$$
wherein, (xtc_{i,j,k}, ytc_{i,j,k}) represents position information of projection of a pixel in an ith row and a jth column in the liquid crystal display panel on the light control panel under a kth angle of view corresponding to position information of a kth user eye; (xmc_{i,j}, ymc_{i,j}, zmc_{i,j}) represents position information of the pixel in the ith row and the jth column in the liquid crystal display panel; (xeₖ, yeₖ, zeₖ) represents the position information of the kth user eye; d represents the gap thickness between the light control panel and the liquid crystal display panel; i and j are positive integers, and k is a positive integer smaller than or equal to N.

5. The display method according to claim 1, wherein the adjusting the original grayscale data according to the N pixel correspondences to obtain target grayscale data comprises:
obtaining N grayscale data to be processed corresponding to the N pixel correspondences one-to-one according to the original grayscale data and the N pixel correspondences; and
determining the target grayscale data based on the N grayscale data to be processed.

6. The display method according to claim 5, wherein the obtaining N grayscale data to be processed corresponding to the N pixel correspondences one-to-one according to the original grayscale data and the N pixel correspondences comprises:
for each pixel correspondence, calculating grayscale data to be processed corresponding to the pixel correspondence based on the pixel correspondence and the original grayscale data by the following formula:
$$IM {G}_{k} = [ \begin{matrix}Sum ( {T}_{k} ( 1 , 1 ) \times IM {G}_{0} ) & … & Sum ( {T}_{k} ( 1 , q ) \times IM {G}_{0} ) \\ ⋮ & ⋱ & ⋮ \\ Sum ( {T}_{k} ( p , 1 ) \times {IMG}_{0} ) & … & Sum ( {T}_{k} ( p , q ) \times IM {G}_{0} )\end{matrix} ] ;$$
wherein, IMGₖ represents grayscale data to be processed corresponding to a kth pixel correspondence; Sum(·) represents summation; IMG₀ represents the original grayscale data; Tₖ(1,1) represents a sub-pixel correspondence corresponding to a pixel in a first row and a first column in the light control panel under an angle of view corresponding to position information of a kth user eye; Tₖ(1,q) represents a sub-pixel correspondence corresponding to a pixel in the first row and a qth column in the light control panel under the angle of view corresponding to the position information of the kth user eye; Tₖ(p,1) represents a sub-pixel correspondence corresponding to a pixel in a pth row and the first column in the light control panel under the angle of view corresponding to the position information of the kth user eye; Tₖ(p,q) represents a sub-pixel correspondence corresponding to a pixel in the pth row and the qth column in the light control panel under the angle of view corresponding to the position information of the kth user eye; p and q are positive integers; k is a positive integer smaller than or equal to N.

7. The display method according to claim 5, wherein the determining the target grayscale data based on the N grayscale data to be processed comprises:
superposing the N grayscale data to be processed to calculate processed grayscale data;
taking the processed grayscale data as the target grayscale data; or smoothing the processed grayscale data to obtain smoothed grayscale data, and taking the smoothed grayscale data as the target grayscale data.

8. The display method according to claim 6, wherein the determining the target grayscale data based on the N grayscale data to be processed comprises:
superposing the N grayscale data to be processed to calculate processed grayscale data;
taking the processed grayscale data as the target grayscale data; or smoothing the processed grayscale data to obtain smoothed grayscale data, and taking the smoothed grayscale data as the target grayscale data.

9. The display method according to claim 7, wherein the superposing the N grayscale data to be processed to calculate processed grayscale data comprises:
calculating the processed grayscale data by the following formula:
IMG=MAX(IMG₁,IMG₂, . . . ,IMG_{N})
wherein, IMG represents the target grayscale data, IMG₁ represents a first grayscale data to be processed, IMG₂ represents a second grayscale data to be processed, IMG_{N} represents a Nth grayscale data to be processed, and MAX (·) represents a matrix composed of larger elements among elements corresponding to the N grayscale data to be processed.

10. The display method according to claim 7, wherein the smoothing the processed grayscale data to obtain smoothed grayscale data comprises:
smoothing the processed grayscale data by any one of an image mean smoothing filtering, a Gaussian filtering and a median filtering to obtain the smoothed grayscale data.

11. The display method according to claim 1, wherein the obtaining position information of N user eyes comprises:
obtaining a first image and a second image through a binocular camera; and
obtaining the position information of the N user eyes based on position information of the binocular camera, the first image and the second image.

12. The display method according to claim 11, wherein the obtaining the position information of the N user eyes based on position information of the binocular camera, the first image and the second image comprises:
determining first pixel positions of the N user eyes in the first image and second pixel positions of the N user eyes in the second image; and
calculating the position information of the N user eyes based on the position information of the binocular camera and the first pixel positions of the N user eyes in the first image and the second pixel positions of the N user eyes in the second image.

13. The display method according to claim 1, wherein the original grayscale data comprises an original sub-grayscale value corresponding to each pixel in the liquid crystal display panel for enabling the pixel in the liquid crystal display panel to display.

14. The display method according to claim 1, wherein the obtaining position information of N user eyes and original grayscale data of an image to be displayed comprises:
obtaining a first image and a second image through a binocular camera in a display apparatus;
obtaining the position information of the N user eyes based on position information of the binocular camera, the first image and the second image.

15. The display method according to claim 14, wherein the obtaining the position information of the N user eyes based on position information of the binocular camera, the first image and the second image comprises:
determining first pixel positions of the N user eyes in the first image and the second pixel positions of the N user eyes in the second image by using a human eye recognition technology; and
calculating the position information of the N user eyes based on the position information of the binocular camera, the first pixel positions of the N user eyes in the first image and the second pixel positions of the N user eyes in the second image by using a binocular visual positioning technology.

16. A non-transient computer readable storage medium, comprising a stored program, wherein a device where the storage medium is located is controlled to execute acts of the display method according to claim 1 when the program is run.

17. A display optimization apparatus, comprising: a processor and a memory storing a computer program that is capable of running on the processor, wherein a display method applied to a display apparatus comprising a light control panel and a liquid crystal display panel which are stacked is implemented when the processor executes the computer program, and the display method comprises:
obtaining position information of N user eyes and original grayscale data of an image to be displayed, wherein N is a positive integer greater than 1;
determining N pixel correspondences corresponding to the position information of the N user eyes one-to-one based on the position information of the N user eyes, wherein a pixel correspondence corresponding to position information of each user eye is a correspondence between pixels in a light control panel and pixels in a liquid crystal display panel under an angle of view corresponding to the position information of the user eye;
adjusting the original grayscale data according to the N pixel correspondences to obtain target grayscale data; and
outputting the original grayscale data to the liquid crystal display panel and outputting the target grayscale data to the light control panel to perform display.

18. An electronic device, comprising: a display apparatus, a binocular camera, and the display optimization apparatus according to claim 17, wherein,
the display apparatus comprises a light control panel and a liquid crystal display panel located on a light-emitting side of the light control panel; and
the binocular camera is configured to capture a first image and a second image.

19. The electronic device according to claim 18, wherein the display apparatus further comprises a backlight module disposed on a side of the light control panel away from the liquid crystal display panel, and the binocular camera is an infrared camera disposed between the backlight module and the light control panel.

20. The electronic device according to claim 19, wherein the backlight module comprises a light source assembly and a plastic frame located on a light-emitting side of the light source assembly, wherein the light source assembly is configured to supply an initial backlight to the light control panel; the plastic frame comprises a bearing part disposed to bear and fix the light control panel; and the infrared camera is disposed on a side of the bearing part away from the light control panel.
